(19) United States
(12) Patent Application Publication
(10) Pub. No.: US 2026/0050416 A1
(43) Pub. Date: Feb. 19, 2026

(54) METHOD AND DEVICE FOR PROCESSING DATA ASSOCIATED WITH A SOFTWARE COMPONENT FOR A PRODUCT

(71) Applicant: Robert Bosch GmbH, Stuttgart (DE)

(72) Inventors: Armin Bauer, Waiblingen (DE); Daniel Tuchscherer, Bempflingen (DE); Florian Kraemer, Pfedelbach (DE); Heiko Baur, Goeppingen (DE); Matthias Hartl, Dollnstein (DE)

(21) Appl. No.: 19/237,560

(22) Filed: Jun. 13, 2025

(30) Foreign Application Priority Data
Jun. 26, 2024 (DE) 10 2024 205 933.1

(51) Int. Cl. G06F 8/30; G06F 8/41

(52) U.S. Cl. CPC G06F 8/316; G06F 8/41

(57) ABSTRACT

A method for processing data associated with a software component for a product. The method includes: providing metainformation associated with a back-end of a development environment for the software component, supplementing an intermediate representation, for example associated with the software component, based on the metainformation.

### FIELD

The present invention relates to a method for processing data associated with a software component for a product.

The present invention further relates to a device for processing data associated with a software component for a product.

### SUMMARY

Some examples of the present invention relate to a method, for example a computer-implemented method, for processing data associated with a software component for a product, comprising: providing metainformation, for example first metainformation, associated with a back-end of a development environment for the software component, supplementing an intermediate representation, for example associated with the software component, based on the, for example, first metainformation. In some examples, this allows for backward-directed annotation, for example related to a development process regarding the software component, which can, in some examples, be used for optimization.

In some examples of the present invention, it is provided that the method comprises: optimizing at least one aspect of a development process for the software component based on the, for example, first metainformation, wherein, for example, the optimizing comprises: arranging data associated with the software component, for example in a memory, for example in order to allow for efficient memory accesses.

In some examples of the present invention, the first metainformation can be generated, for example, by the back-end or generally by one or more back-ends of the development environment.

In some examples of the present invention, it is provided that the method comprises: providing first information that characterizes at least one aspect associated with the software component, for example specific to a domain of the product, and, optionally, supplementing the software component with the first information.

In some examples of the present invention, providing the first information allows for efficient processing of the software component, for example in one or more stages of a development environment. In some examples, for example, a comparatively modular development environment, e.g., based on an LLVM compiler system, can be used, and the provision of the first information allows, for example, for a supplementation of a modular development process, e.g., based on the LLVM compiler system, with an annotation, e.g., directed forward, as can be characterized or formed, e.g., by the first information. In addition, the provision of the metainformation, which is associated with the back-end of the development environment for the software component, as mentioned above, allows for backward-directed annotation. In some examples, an optimization can be carried out based on the backward-directed annotation and/or the forward-directed annotation, e.g., with regard to a development process, e.g., with regard to the software component.

In some examples of the present invention, the forward-directed annotation, which, for example, like the backward-directed information, can be understood as, for example, second metainformation, can supplement, for example, the intermediate representation of an LLVM system in such a way that domain-specific information is forwarded, for example, to a back-end.

In some examples of the present invention, the domain-specific information relates to e.g., an automotive domain (e.g., the domain of motor vehicles). In some examples, the intermediate representation can thus be supplemented both by means of the backward-directed annotation, e.g., on the basis of the corresponding, for example first, metainformation, and by means of the forward-directed annotation, e.g., also on the basis of corresponding, for example second, metainformation.

In some examples of the present invention, the software component characterizes at least one of the following elements: a) source code, for example in a high-level language such as C or C++, or b) bytecode, for example virtual bytecode, or c) for example platform-independent representation, for example what is known as intermediate representation, for example according to the “LLVM Project,” see e.g., www.llvm.org, or d) machine code, for example executable on a computing device.

In some examples of the present invention, it is provided that the method comprises: providing at least a part of the first information in the form of, e.g., second, metainformation, for example for at least one stage of a development process associated with the software component, for example for a back-end of a compiler.

In some examples of the present invention, it is provided that the method comprises: using the first information for at least one processing step and/or for at least one stage of a development process associated with the software component.

In some examples of the present invention, it is provided that the using comprises: forwarding at least a part of the first information to a back-end of a development environment for the software component, for example to a back-end of a compiler for the software component.

In some examples of the present invention, it is provided that the development environment has at least one compiler having a front-end and a back-end, wherein the method comprises at least one of the following elements: a) providing at least a part of the first information for the front-end of the compiler, or b) providing at least a part of the first information for the back-end of the compiler.

In some examples of the present invention, it is provided that the first information comprises at least one of the following elements: a) information relating to freedom from interference, for example associated with at least one integrity objective, for example according to Automotive Safety Integrity Level, ASIL, or b) information characterizing an integrity objective, or c) information for defending against side-channel attacks, d) information for generating code for generating profiling information.

In some examples of the present invention, it is provided that the method comprises: generating code for increasing resistance to side-channel attacks, for example in a back-end or the back-end of a compiler or the compiler, and, optionally, using the code for increasing resistance to side-channel attacks.

Some examples of the present invention relate to a device for carrying out the method according to the disclosure.

Some examples of the present invention relate to a computer-readable storage medium comprising commands that, when executed by a computer, cause said computer to carry out the method according to the disclosure.

Some examples of the present invention relate to a computer program comprising commands that, when the computer program is executed by a computer, cause said computer to carry out the method according to the disclosure.

Some examples of the present invention relate to a data carrier signal that characterizes and/or transmits the computer program according to the disclosure.

Some examples of the present invention relate to a use of the method according to the disclosure and/or of the device according to the disclosure and/or of the computer-readable storage medium according to the disclosure and/or of the computer program according to the disclosure and/or of the data carrier signal according to the disclosure for at least one of the following elements: a) annotating at least a part of the software component, for example by means of application-specific information, or b) providing, for example, application-specific information for a back-end of a compiler, or c) increasing a security of, for example, the software component, or d) providing backward-directed annotation, for example with regard to a development process, or e) performing optimizations, for example based on the forward-directed annotation and/or on the backward-directed annotation, or f) providing a software component for chiplet systems.

Further features, possible applications and advantages of the present invention can be found in the following description of examples of the present invention, which are shown in the figures. In this case, all of the features described or shown form the subject matter of the present invention individually or in any combination, irrespective of their wording or representation in the description or in the figures.

### BRIEF DESCRIPTION OF THE DRAWINGS

FIG. 1 schematically shows a simplified flow chart, according to an example embodiment of the present invention.

FIG. 2 schematically shows a simplified block diagram, according to an example embodiment of the present invention.

FIG. 3 schematically shows a simplified flow chart, according to an example embodiment of the present invention.

FIG. 4 schematically shows a simplified flow chart, according to an example embodiment of the present invention.

FIG. 5 schematically shows a simplified flow chart, according to an example embodiment of the present invention.

FIG. 6 schematically shows a simplified block diagram, according to an example embodiment of the present invention.

FIG. 7 schematically shows a simplified block diagram, according to an example embodiment of the present invention.

FIG. 8 schematically shows a simplified block diagram, according to an example embodiment of the present invention.

FIG. 9 schematically shows a simplified block diagram, according to an example embodiment of the present invention.

FIG. 10 schematically shows a simplified block diagram, according to an example embodiment of the present invention.

FIG. 11 schematically shows examples of uses, according to an example embodiment of the present invention.

### DETAILED DESCRIPTION OF THE DRAWINGS

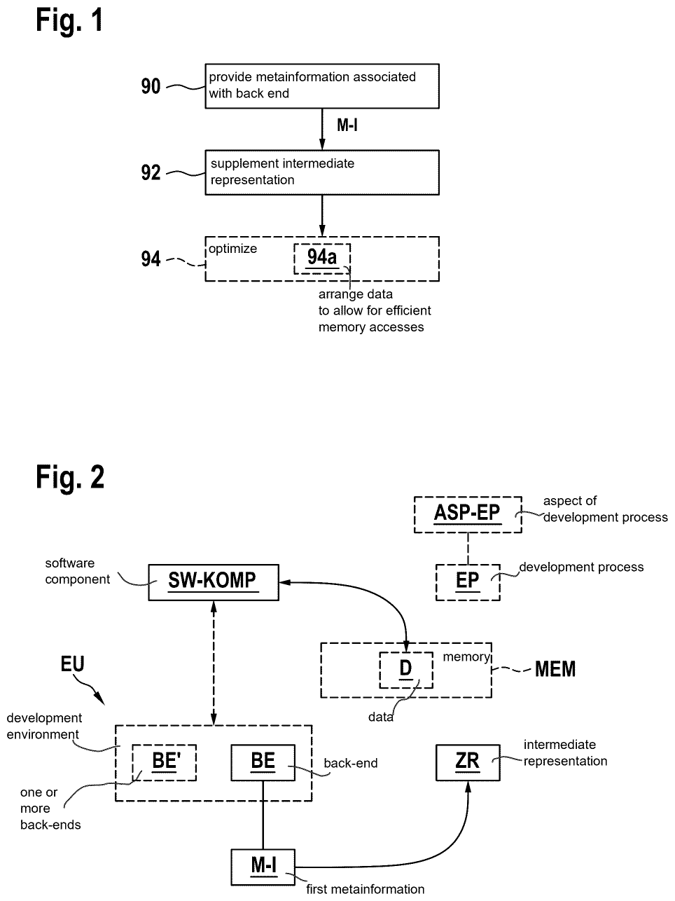

Some examples, FIGS. 1, 2, relate to a method, for example a computer-implemented method, for processing data associated with a software component SW-KOMP for a product 1, 10 (FIG. 9), comprising: providing 90 (FIG. 1) metainformation M-I, for example first metainformation, associated with a back-end BE (FIG. 2) of a development environment EU for the software component SW-KOMP, supplementing 92 an intermediate representation ZR, for example associated with the software component SW-KOMP, based on the, for example first, metainformation M-I. In some examples, this allows for backward-directed annotation, for example related to a development process EP regarding the software component SW-KOMP, which can, in some examples, be used for optimization.

In some examples, FIG. 1, it is provided that the method comprises: optimizing 94 at least one aspect ASP-EP of a or of the development process EP for the software component SW-KOMP based on the, for example, first metainformation M-I, wherein, for example, the optimizing 94 comprises: arranging 94a data D associated with the software component SW-KOMP, for example in a memory MEM, for example in order to allow for efficient memory accesses.

In some examples, the first metainformation M-I can be generated, for example, by the back-end BE or generally by one or more back-ends BE′ of the development environment EU.

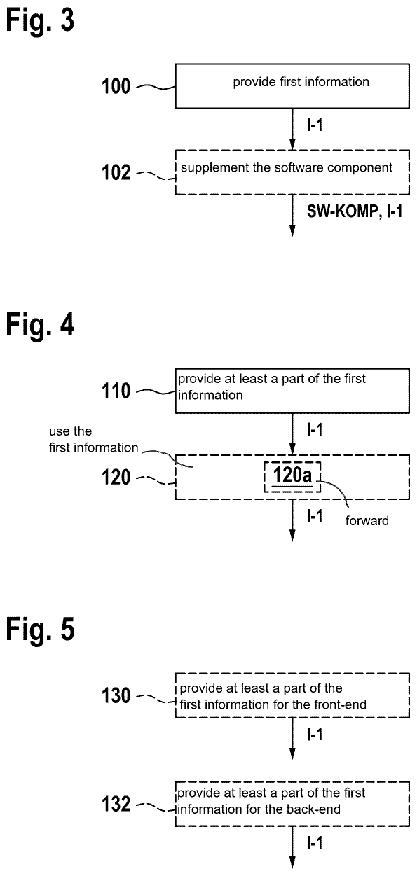

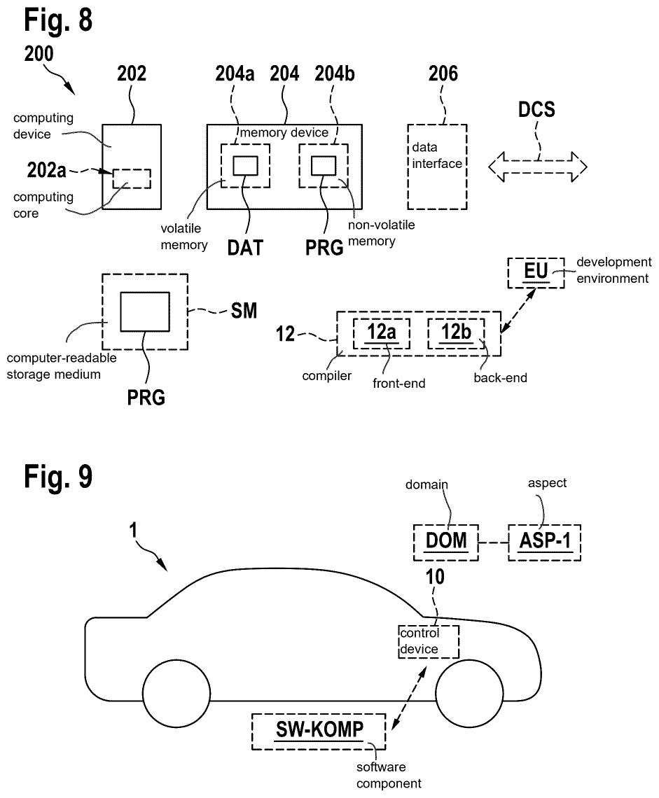

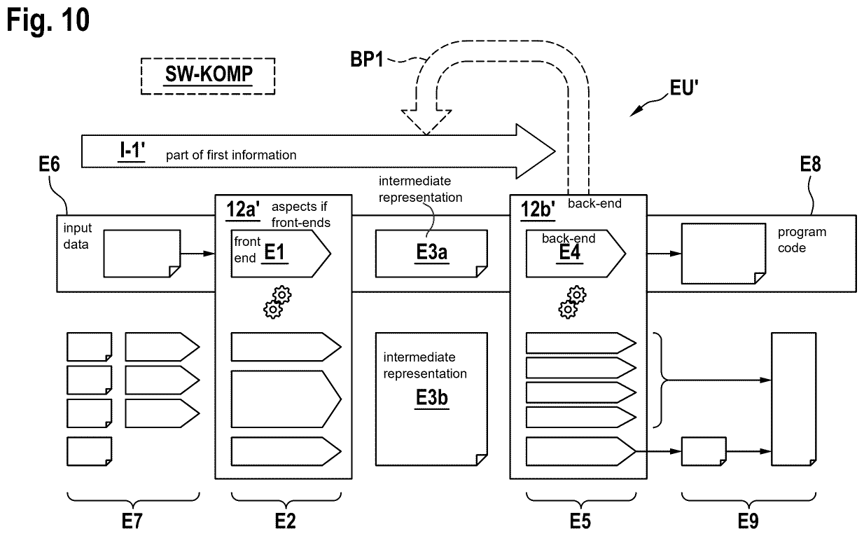

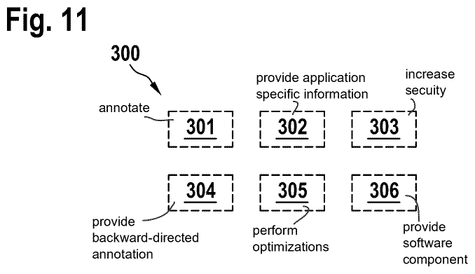

In some examples, FIG. 3, it is provided that the method comprises: providing 100 first information I-1 that characterizes at least one aspect ASP-1 associated with the software component SW-KOMP, for example specific to a domain DOM (see FIG. 9) of the product 1, 10, and, optionally, supplementing 102 the software component SW-KOMP with the first information I-1. In some examples, this allows for efficient processing of the software component SW-KOMP, for example in one or more stages of a development environment EU (see FIGS. 8, 10).

In some examples, for example, a comparatively modular development environment, e.g., based on an LLVM compiler system, can be used, and the provision of the first information I-1 allows, for example, for a supplementation of a modular development process, e.g., based on the LLVM compiler system, with an annotation, e.g., directed forward, as can be characterized or formed, e.g., by the first information I-1. In addition, the provision 90 of, for example, the first metainformation M-I, which is associated with the back-end BE of the development environment EU for the software component SW-KOMP, as mentioned above, allows for backward-directed annotation. In some examples, an optimization can be carried out based on the backward-directed annotation and/or the forward-directed annotation, e.g., with regard to a development process, e.g., with regard to the software component.

In some examples, the forward-directed annotation, which, for example, like the backward-directed information, can be understood as, for example, second metainformation, can supplement, for example, the intermediate representation ZR (FIG. 2) of an LLVM system in such a way that domain-specific information is forwarded, for example, to a or the back-end BE or at least one back-end BE, BE′. In some examples, the domain-specific information relates to e.g., an automotive domain (e.g., the domain of motor vehicles). In some examples, the intermediate representation ZR (FIG. 2) can thus be supplemented both by means of the backward-directed annotation, e.g., on the basis of the corresponding, for example first, metainformation M-I (FIGS. 1, 2), and by means of the forward-directed annotation, e.g., also on the basis of corresponding, for example second, metainformation (see the first information I-1, e.g., according to FIG. 3).

In some examples, the software component SW-KOMP characterizes at least one of the following elements: a) source code, for example in a high-level language such as C or C++, or b) bytecode, for example virtual bytecode, or c) for example platform-independent representation, for example what is known as intermediate representation, for example according to the “LLVM Project,” see e.g., www.llvm.org, or d) machine code, for example executable on a computing device.

In some examples, FIG. 9, the product is, for example, a vehicle, for example motor vehicle, 1, or a control device 10 for a vehicle, for example motor vehicle, 1.

In some examples, FIG. 4, it is provided that the method comprises: providing 110 at least a part of the first information I-1 in the form of, e.g., second, metainformation, for example for at least one stage of a development process EP associated with the software component SW-KOMP, for example for at least one back-end BE, BE′ (FIG. 2) of a compiler.

In some examples, FIG. 4, it is provided that the method comprises: using 120 the first information I-1 for at least one processing step and/or for at least one stage of a development process associated with the software component SW-KOMP. In some examples, using 120 can also comprise using the, for example first, metainformation M-I. In other words, in some examples, the method can comprise: using the, for example first, metainformation M-I and/or the first information I-1, for example in the form of second metainformation, for the at least one stage of the development process EP associated with the software component SW-KOMP (FIG. 2).

In some examples, FIG. 4, it is provided that the using 120 comprises: forwarding 120a at least a part of the first information I-1 to a back-end BE (FIGS. 2), 12b (FIG. 8) of a development environment EU for the software component SW-KOMP, for example to a back-end of a compiler for the software component.

In some examples, FIGS. 5, 8, it is provided that the development environment EU has at least one compiler 12 having a front-end 12a and a back-end 12b (see also the elements BE, BE′ according to FIG. 2), wherein the method has at least one of the following elements: a) providing 130 at least a part of the first information I-1 for the front-end 12a of the compiler 12, or b) providing 132 at least a part of the first information I-1 for the back-end BE, BE′, 12b of the compiler 12.

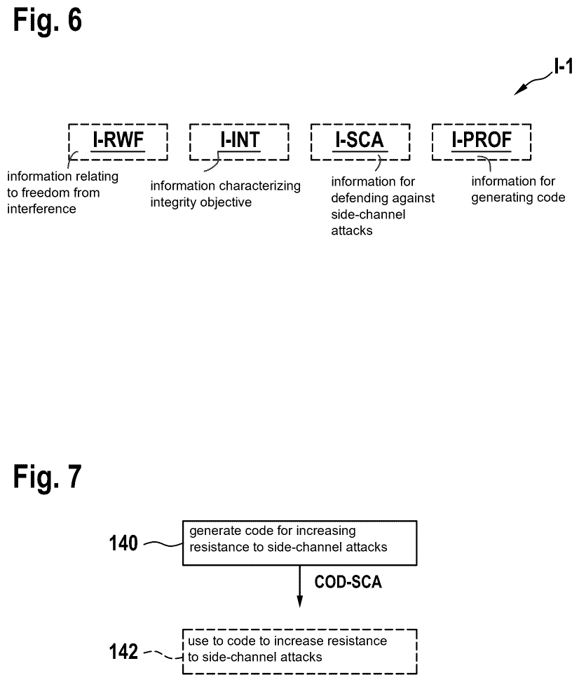

In some examples, FIG. 6, it is provided that the first information I-1 comprises at least one of the following elements: a) information I-RWF relating to freedom from interference, for example associated with at least one integrity objective, for example according to Automotive Safety Integrity Level, ASIL, or b) information I-INT characterizing an integrity objective, or c) information I-SCA for defending against side-channel attacks, d) information I-PROF for generating code for generating profiling information.

In some examples, one or more of the following aspects are considered, for example for the information I-RWF relating to freedom from interference. In some examples, the first information I-1 can be used to achieve freedom from interference for different integrity objectives (e.g., according to ASIL), for example, in order to comply with safety requirements.

In some examples, the first information I-1 can be used, for example, to create a configuration for memory protection measures, e.g., for at least one memory protection device, for example automatically, e.g., without manual interaction.

In some examples, the first information I-1 can be used, for example, to automatically implement freedom from interference. Optionally, in some examples, the configuration for the memory protection measures can be checked by a human expert.

In some examples, one or more of the following aspects are considered, for example for the information I-INT that characterizes an integrity objective. In some examples, comparatively high safety objectives (e.g., ASIL-C/D) require e.g., redundancy, e.g., to achieve a required error detection rate as risk minimization (e.g., 99% detection of single errors with ASIL-D). If, for example, an ASIL classification were known in a back-end 12b, targeted redundancy could be realized, for example, with coded processing. In some examples, the first information I-1, for example the information I-INT characterizing an integrity objective, can therefore be used to inform the back-end 12b about the ASIL classification.

In some examples, one or more of the following aspects are considered, for example for the information I-SCA for defending against side-channel attacks.

In some examples, automatic code generation, e.g., in a back-end 12b, can increase resistance to side-channel attacks. In some examples, the goal can, for example, be to ensure the integrity and/or confidentiality of a data item or a calculation step.

In some examples, the software component SW-KOMP (FIG. 9), e.g., a code, can be enriched e.g., with the following information, for example metainformation, that characterizes at least one of the following elements: · a data item does not physically leave a secured region (protection objective: confidentiality), · the integrity of a data item must be ensured (protection objective: integrity), · a calculation must be carried out multiple times redundantly for security reasons (protection objective:

integrity), · power consumption must be kept constant (to prevent an SPA/DPA analysis; protection objective: confidentiality), · the processing duration of a computation step must be kept constant (protection objective: confidentiality), · a computation operation must be performed in such a way that no inferences can be drawn from the electromagnetic radiation, (protection objective: confidentiality), · a computation operation must be physically distributed over the area of the processor, e.g., in such a way that a targeted placement of probes becomes difficult, (protection objective: confidentiality), · sound analysis should not be possible, (protection objective: confidentiality). In other words, in some examples, the first information I-1 can comprise at least one of the items of information I-SCA mentioned above by way of example or any combination thereof.

In some examples, the first information I-1 can characterize, for example, how to react in the event of an attack (e.g., on a product 1, 10 having the software component SW-KOMP or on a product associated with the software component SW-KOMP) (e.g., the integrity of a data item is not correct, a glitch attack has been detected, etc.). For example: a) in the event of a detected attack, it would be possible (e.g., for the product) to abort the computation operation and enter a defined error state, or b) it would be possible (e.g., for the product) to repeat the computation operation, or c) it would be possible (e.g., for the product) to repeat the computation operation n times and then abort, or d) it would be possible (e.g., for the product) to repeat computations on another device, etc. In other words, in some examples, the first information I-1 can comprise at least one of the items of information mentioned above by way of example or any combination thereof, on the basis of which the product can, for example, react to an attack.

In some examples, one or more of the following aspects are considered, for example for the information I-PROF for generating code for generating profiling information. For example, the software component SW-KOMP (FIG. 9) can be enriched with at least one annotation, which, for example, generates code in at least one downstream process step that generates profiling information. In some examples, the profiling information can comprise at least one of the following elements: a) timing information, or b) data, for example statistical data, about function calls, or c) memory usage, or d) information about caches (e.g., cache hits/misses), or e) temperature trends, or f) power consumption, or g) idle cycles, or h) code coverage, etc.

In some examples, FIG. 7, it is provided that the method comprises: generating 140 code COD-SCA for increasing resistance to side-channel attacks, for example in a back-end or the back-end BE, BE′ (FIGS. 2), 12b (FIG. 8) of a compiler or the compiler 12, and, optionally, using 142 the code COD-SCA to increase resistance to side-channel attacks.

Some examples, FIG. 8, relate to a device 200 for carrying out the method according to the disclosure.

In other examples, FIG. 8, it is provided that the device 200 comprises: a computing device (“computer”) 202 having at least one computing core 202a, a memory device 204 assigned to the computing device 202 for at least temporarily storing at least one of the following elements: a) data DAT (e.g., data associated with the software component SW-KOMP and/or data associated with the, for example first, metainformation M-I and/or the first information I-1 (e.g., in the form of second metainformation) and/or data associated with the development environment EU), b) computer program PRG, for example for carrying out the method according to the embodiments.

In further examples, the memory device 204 has a volatile memory (e.g., a random access memory (RAM) ) 204a, and/or a non-volatile (NVM) memory (e.g., a flash EEPROM) 204b, or a combination thereof or with other types of memory not explicitly mentioned.

Some examples, FIG. 8, relate to a computer-readable storage medium SM comprising commands PRG that, when executed by a computer 202, cause said computer to carry out the method according to the disclosure.

Some examples, FIG. 8, relate to a computer program PRG comprising commands that, when the computer program PRG is executed by a computer 202, cause said computer to carry out the method according to the disclosure.

Some examples, FIG. 8, relate to a data carrier signal DCS that characterizes and/or transmits the computer program PRG according to the disclosure. The data carrier signal DCS can be received, for example, via an optional data interface 206 of the device 200.

FIG. 10 schematically shows a simplified block diagram with aspects of a development environment EU in which aspects according to the examples can be used. Element E12a′ symbolizes aspects of one or more front-ends, and element E12b′ symbolizes aspects of one or more back-ends (see also components BE, BE′ according to FIG. 2) according to some examples.

Element E1 symbolizes a front-end, for example an LLVM front-end, as can, in some examples, be part of the development environment EU for software components, e.g., having an LLVM compiler system. Element E2 symbolizes further optional front-ends, for example of type AST, or Clang, etc. Element E3a symbolizes an intermediate representation (see also element ZR according to FIG. 2) (e.g., machine-oriented intermediate language), IR, for example an LLVM IR, which is associated with the front-end E1, for example. Element E3b symbolizes an intermediate representation, IR, for example an LLVM IR, which is associated with the front-end(s) E2, for example. The elements E4 and E5 each symbolize aspects of corresponding back-ends.

Element E6 symbolizes input data for the front-end E1, e.g., in the form of a code, represented, e.g., in a computer programming language, e.g., C or C++. In a similar way, element E7 symbolizes input data for the at least one other front-end E2.

Element E8 symbolizes a program code, for example machine code, as can, in some examples, be formed by the back-end E4, e.g., based at least on the input data E6.

Element E9 symbolizes a program code, for example machine code, as can, in some examples, be formed by the optional back-end(s) E5, e.g., based at least on the input data E7.

The dashed block arrow BP1 symbolizes the metainformation M-I according to the disclosure, see also FIGS. 1, 2, which can be provided, for example, by at least one back-end 12b′, for example for the intermediate representation E3a, E3b. For example, the metainformation M-I allows for backward annotation, as described above.

Element I-1′symbolizes at least a part of the first information I-1 according to some examples, which in some examples can be used, for example, for forward annotation of at least some of the input data E6, E7 (and/or data derived therefrom, see, for example, the blocks E3a, E3b), and which can be used, for example, evaluated, in later stages E3a, E3b, E4, E5. As a result, in some examples, at least one domain-specific aspect ASP-1 can advantageously be taken into account, which domain-specific aspect is associated with a software component SW-KOMP that can be processed by the configuration according to FIG. 8.

Some examples, FIG. 11, relate to a use 300 of the method according to the disclosure and/or of the device 200 according to the disclosure and/or of the computer-readable storage medium SM according to the disclosure and/or of the computer program PRG according to the disclosure and/or of the data carrier signal DCS according to the disclosure for at least one of the following elements: a) annotating 301 at least a part of the software component SW-KOMP, for example by means of application-specific information, or b) providing 302, for example, application-specific information for a back-end 12b of a compiler 12, or c) increasing 303 a security of, for example, the software component, or d) providing 304 backward-directed annotation, for example with regard to a development process, or e) performing 305 optimizations, for example based on the forward-directed annotation and/or on the backward-directed annotation, or f) providing (306) software component (SW-KOMP) for chiplet systems.

In some examples, at least some of the information M-I, I-1, e.g., in cyclic executions of components of the development environment EU, can be used to perform system-wide optimizations. In some examples, the single back-end BE, 12b is accordingly provided with more information (e.g., M-I and/or I-1), e.g., to make optimization decisions based thereon, than is the case with conventional approaches.

In some examples, using the principle according to the disclosure, the effort required to develop software components, for example for control units, for example for motor vehicles, can be reduced, for example even though a comparatively modular configuration, e.g., according to FIG. 10, is used.

In some examples, using the principle according to the disclosure, software development, for example for the automotive sector and/or other sectors where e.g., there is a comparatively high variance in projects with, e.g., a wide variety of computing machines, for example SoC (system-on-chip), for example chiplets, can be efficiently designed or supported.

In some examples, using the principle according to the disclosure, e.g., security requirements, e.g., according to ISO 26262, can be implemented, for example met.

In some examples, using the principle according to the disclosure, e.g., optimizations can be carried out for specific use cases, wherein, for example, domain-specific information concerning the specific use cases can be characterized by means of the first information I-1.

In some examples, using the principle according to the disclosure, e.g., cybersecurity requirements, e.g., for the automotive sector, can be implemented, for example met.

In some examples, the principle according to the disclosure can be used, for example, to develop driver assistance applications for motor vehicles. In some examples, such a development can, for example, comprise at least three phases: 1) concept phase, e.g., using hardware other than a target hardware for the software component SW-KOMP, 2) embedded phase, wherein the software component SW-KOMP, e.g., an application, is brought onto the actual target hardware, e.g., an SoC, 3) series. For example, for the series phase, in addition to porting the software component SW-KOMP to the target hardware (see, e.g., phase: embedded), for example all safety and/or security requirements are also implemented and taken into account, wherein a comparatively large variance in the hardware used can arise. By enriching processing steps in the development of the software components, e.g., with domain-specific properties, e.g., based on the principle according to the disclosure, the development of, e.g., driver assistance applications for motor vehicles can be made efficient and flexible.

The principle according to the disclosure can advantageously be used for (but not limited to) processing software components SW-KOMP for automotive applications (i.e., applications from the motor vehicle sector), which are implemented, for example, using chiplet technology.

The principle according to the disclosure can advantageously be used for (but not limited to) processing software components SW-KOMP for control units 10, for example central control units (e.g., for ADAS, advanced driver assistance systems) and/or vehicle computers for vehicles 1 (FIG. 9).

The principle according to the disclosure can advantageously be used for development environments EU where different hardware (e.g., in the form of different chiplets) interacts with different back-ends BE, BE′ (FIG. 2), e.g., together in a system 10, e.g., in fault-tolerant safety systems and/or chiplet systems.

1-14. (canceled)

15. A computer-implemented method for processing data associated with a software component for a product, the method comprising the following steps:
providing metainformation associated with a back-end of a development environment for the software component; and
supplementing based on the metainformation an intermediate representation associated with the software component.

16. The method according to claim 15, further comprising:
optimizing, based on the metainformation, at least one aspect of a development process for the software component, wherein the optimizing includes arranging data associated with the software component in a memory.

17. The method according to claim 15, further comprising:
providing first information that characterizes at least one aspect associated with the software component, specific to a domain of the product; and
supplementing the software component with the first information.

18. The method according to claim 17, further comprising:
providing at least a part of the first information in the form of metainformation, for at least one stage of a development process associated with the software component.

19. The method according to claim 17, further comprising:
using the first information for at least one processing step and/or for at least one stage of a development process associated with the software component.

20. The method according to claim 19, wherein the using includes: forwarding at least a part of the first information to a back-end of a development environment for the software component.

21. The method according to claim 19, wherein the using includes: forwarding at least a part of the first information to a back-end of a compiler for the software component.

22. The method according to claim 20, wherein the development environment has at least one compiler having a front-end and a back-end, abd wherein the method comprises at least one of the following elements: a) providing at least a part of the first information for the front-end of the compiler, or b) providing at least a part of the first information for the back-end of the compiler.

23. The method according to claim 17, wherein the first information includes at least one of the following elements: a) information relating to freedom from interference, or b) information characterizing an integrity objective, or c) information for defending against side-channel attacks, d) information for generating code for generating profiling information.

24. The method according to claim 15, further comprising:
generating code for increasing resistance to side-channel attacks, in a back-end of a compiler, and using the code to increase resistance to the side-channel attacks.

25. A device for for processing data associated with a software component for a product, the method comprising the following steps:
providing metainformation associated with a back-end of a development environment for the software component; and
supplementing based on the metainformation an intermediate representation associated with the software component.

26. A non-transitory computer-readable storage medium on which are stored commands for processing data associated with a software component for a product, the commands, when executed by a computer, causing the computer to perform the following steps:
providing metainformation associated with a back-end of a development environment for the software component; and
supplementing based on the metainformation an intermediate representation associated with the software component.

27. The method according ot claim 13, wherein the method is used for at least one of the following elements: a) annotating at least a part of the software component using application-specific information, or b) providing application-specific information for a back-end of a compiler, or c) increasing a security of the software component, or d) providing backward-directed annotation with regard to a development process, or e) performing optimizations, f) providing the software component for chiplet systems.
